(19) United States
(12) Patent Application Publication
(10) Pub. No.: US 2009/0215002 A1
(43) Pub. Date: Aug. 27, 2009

(54) Teeth separation devices and methods of use thereof

(76) Inventor: James Mah, Las Vegas, NV (US)

Correspondence Address: James Mah, P.O. Box 15288, Las Vegas, NV, 89114, US

(21) Appl. No.: 12/380,244

(22) Filed: Feb. 25, 2009

Related U.S. Application Data
(60) Provisional application No. 61/031,326, filed on Feb. 25, 2008.

(51) Int. Cl. A61C 7/10

(52) U.S. Cl. 433/18; 433/24

(57) ABSTRACT

The present invention relates to teeth separators and methods of use thereof. According to certain embodiments of the present invention, devices for separating teeth are provided, which generally comprise a plurality of engaging elements. The engaging elements are interconnected to form a string of the engaging elements. The engaging elements are preferably the same size, and exhibit, for example, a substantially triangular or conical configuration. The devices further include a connecting end which comprises an aperture through which one or more of the engaging elements may pass in a first direction but not in a second (opposite) direction. The aperture may exhibit, for example, a circular configuration.

### CROSS-REFERENCE TO RELATED APPLICATIONS

This application claims priority to, and incorporates by reference, U.S. provisional patent application Ser. No. 61/031,326, filed on Feb. 25, 2008.

### FIELD OF THE INVENTION

The field of the present invention relates to teeth separators and methods of use thereof.

### BACKGROUND OF THE INVENTION

Orthodontic practitioners often need to separate, or increase the distance between, two teeth. The need to separate teeth is typically occasioned by the need to insert a metal ring, which known as a “band,” around a tooth. Attachments such as brackets, lugs, buttons, and other items may be welded to the band, which are necessary for mechanotherapy applications.

There have been a large variety of teeth separators that have been used by orthodontic practitioners over the years. For example, historically, a brass wire was placed around the contact point of the teeth to be separated, which was then twisted to place the wire under tensile stress, thereby causing the wire to contract slightly and push the teeth apart. This technique created high forces over a short period of time resulting in significant discomfort, not to mention the cut twisted end of the brass wire often irritated the patient's gums and other soft tissues. The wire was often replaced to gradually effect tooth separation, until the desired amount of space between the subject teeth was available. While this technique is no longer commonly used, it is occasionally employed as an alternative for patients with extremely tight tooth contacts that do not allow for the placement of elastomeric “O” ring separators, dumbbells or metal spring separators.

The prior art separators further include metal spring separators (e.g., those offered by TP Orthodontics, Inc., La Porte, Ind.). These separators consist of a longer upper arm that is designed to extend over the contact point/area and a shorter lower arm that extends under the contact point. The upper and lower arms are connected through a 360-degree loop bend in the wire. The arms are extended when the device is placed with its upper arm over the contact point, and the lower arm below the separator. This configuration produces a compressive force to bring the arms together and, in doing so, will separate the teeth over the course of at least several days. These metal separators, however, exhibit several drawbacks, namely, these separators are often difficult to insert and properly position, the separators are easily displaced, and carry the concern of a patient inadvertently swallowing a metal component thereof.

Another type of prior art teeth separator is elastomeric “O” rings, which encircle the contact point/area and constrict to separate the teeth. While these separators are the most commonly used devices in teeth separation, they are often difficult to place as they are stretched and placed around the contact point. Indeed, placement of such elastomeric “O” rings is a major problem and special hand instruments are often required (as well as specialized techniques) to stretch the elastic with dental floss. The elastomeric “O” ring separators are extremely difficult, if not impossible, to properly insert between teeth if the contact point between them is very tight. In addition, the forces of stretching the separator during placement often damages the separator, e.g., by overstretching the separator and causing it to lose its ability to effectively separate teeth.

Similarly, elastomeric dumbbells are sometimes used by orthodontic practitioners. These elastomeric dumbbells are stretched during placement and exhibit the same problems as “O” rings during installation, particularly in patients with tight tooth contacts. These separators are generally even more difficult to place than “O” rings, and occupy more space between teeth causing patients even further discomfort and compression of the gingiva.

Accordingly, while several different types of teeth separators have been developed and employed over the years, these separators often exhibit one or more significant drawbacks. As such, there is a continuing need for improved teeth separators and methods of use thereof.

### SUMMARY OF THE INVENTION

According to certain embodiments of the present invention, devices for separating teeth are provided. The devices generally comprise a plurality of engaging elements, which are interconnected to form a string of engaging elements. The engaging elements are preferably the same size, although the engaging elements may vary in size within a single device. The invention provides that -the engaging elements preferably exhibit at least two regions, with a first region exhibiting a greater dimension than a second region, such as an engaging element having a substantially triangular or conical configuration. The devices further include a connecting end which comprises an aperture through which one or more of the engaging elements may pass in a first direction, but not in a second (opposite) direction. The aperture may exhibit, for example, a circular configuration.

According to additional embodiments of the present invention, methods for separating teeth are provided. The methods generally comprise inserting a teeth separator described herein, and looping the teeth separator around the point of contact, between two teeth that are to be separated. As described herein, the preferred teeth separator used in such methods comprises a plurality of interconnected engaging elements, and a connecting end which includes an aperture through which one or more of the engaging elements may pass in a first direction, but not in a second (opposite) direction.

The above-mentioned and additional features of the present invention are further illustrated in the Detailed Description contained herein.

### BRIEF DESCRIPTION OF THE FIGURES

FIG. 1 is a top view of a non-limiting example of a teeth separator of the present invention.

FIG. 2 is a side view of the teeth separator of FIG. 1.

FIG. 3 is an enlarged cross-sectional view of several different types of engaging elements, each of which exhibits a first region (a) that exhibits a greater dimension than a second region (b).

FIG. 4 is an enlarged cross-sectional view of the connecting end of the teeth separator of FIG. 1, which includes an aperture therein.

FIG. 5 is an enlarged cross-sectional view of the triangular or conically-shaped engaging elements of the teeth separator of FIG. 1.

FIG. 6 is a side view of the triangular or conically-shaped engaging elements of the teeth separator of FIG. 1, being pulled through the aperture of the connecting end of the teeth separator in the first direction (with the apex of the engaging elements leading), and the aperture stretching to accommodate the engaging elements.

FIG. 7 is a side view of the triangular or conically-shaped engaging elements of the teeth separator of FIG. 1, having already been pulled through the aperture of the connecting end of the teeth separator in the first direction, and unable to be pulled back through the aperture in a second (opposite) direction.

FIG. 8 is a top view of a non-limiting example of a teeth separator of the present invention, positioned between two teeth to be separated.

FIG. 9 is a side view of a non-limiting example of a teeth separator of the present invention, positioned between two teeth to be separated.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

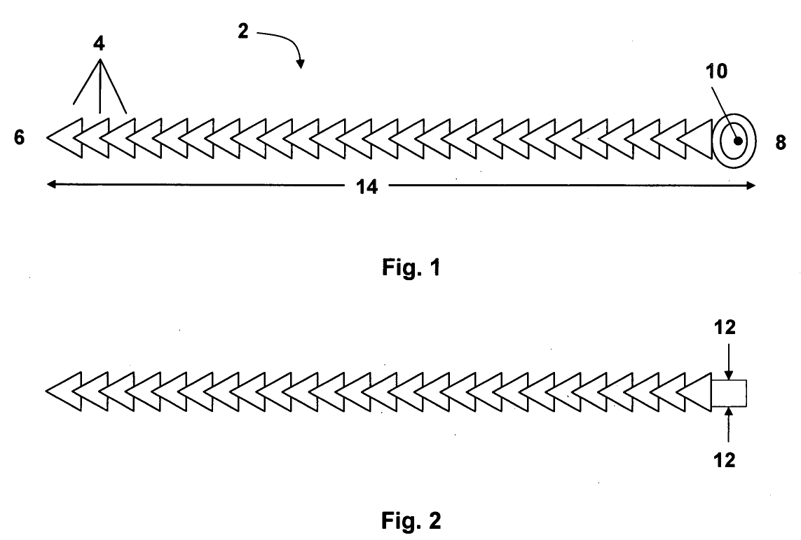

According to certain embodiments of the present invention, devices for separating teeth are provided. Referring to FIG. 1, the teeth separating devices 2 of the present invention generally comprise a plurality of engaging elements 4, which are interconnected to form a string of the engaging elements 4. The total length 14 of the teeth separators 2 may vary, such as between 20-60 mm, or preferably between 30-50 mm, such as most preferably about 40 mm. The teeth separators 2 have two sides, a first side 6 and a second side 8. The second side 8 is also referred to herein as the connecting end 8. The connecting end 8 includes an aperture 10.

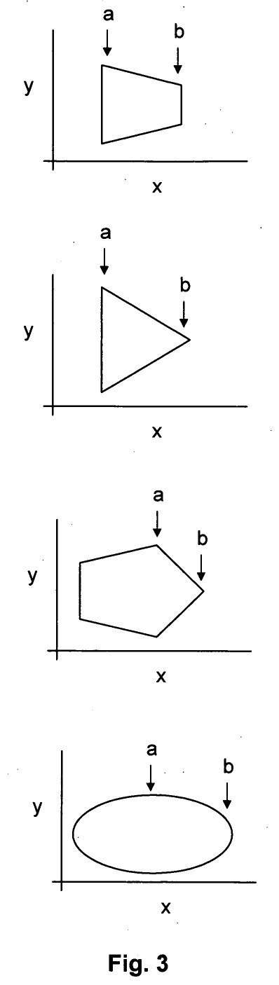

The engaging elements 4 preferably exhibit at least two regions, with a first region exhibiting a greater dimension than a second region. In other words, the invention provides that the engaging elements 4 may exhibit any of a variety of regular and irregular shapes, provided that each engaging element 4 includes a first region exhibiting a greater dimension than a second region. For example, FIG. 3 shows the cross-section of a variety of different engaging elements 4, each of which includes a first region (a) exhibiting a greater dimension than a second region (b). As shown by way of example in FIG. 3, the various engaging elements 4 shown therein comprise a first region (a) exhibiting a greater dimension (i.e., it covers more distance along the y-axis shown therein) than a second region (b). In certain preferred embodiments, the engaging elements 4 have a substantially triangular or conical configuration. In the case of a conical configuration, it should be appreciated that a cross-section thereof will essentially resemble the shape of a triangle.

The engaging elements 4 are preferably the same size and configuration. According to certain preferred embodiments of the invention, and referring to FIGS. 1 and 5, the plurality of engaging elements 4 exhibit a substantially triangular or conical configuration. The size of the engaging elements 4 may vary. In certain preferred embodiments, however, the engaging elements 4 (or, in the case of a conically-shaped engaging element 4, the cross-section thereof) may have three sides 30 of equal length 20, which may range between about 1.0 and 1.5 mm, such as about 1.25 mm.

The aperture 10 at the connecting end 8 may exhibit, for example, a circular, square, rectangular, or other configuration. In certain preferred embodiments, the aperture 10 at the connecting end 8 exhibits a circular configuration, which may have any suitably sized outer diameter 16, such as 1-3 mm, such as about 2 mm. Preferably, the inner diameter 18 of the aperture 10 is smaller than the length 20 of the sides 30 of the engaging elements 4 (or otherwise smaller than the region of the engaging element 4 having the greatest dimension, such as the region (a) of the engaging elements 4 shown in FIG. 3). This way, as described further below, the engaging elements 4 are allowed to pass through the aperture 10 of the connecting end 8 in a first direction, but not in a second (opposite) direction.

More specifically, for example, if each of the sides 30 of triangular or conically-shaped engaging elements 4 are approximately 1.25 mm in length 20, an appropriately sized inner diameter 18 of the aperture 10 may be about 0.5-1.0 mm, such as about 0.75 mm. The thickness 12 (FIG. 2) of the connecting end 8 and aperture 10 may also vary, but should be sufficiently thick and flexible to withstand reasonable pulling forces resulting from the use of the teeth separator 2, such as a thickness 12 of about 1-1.5 mm, such as about 1.25 mm.

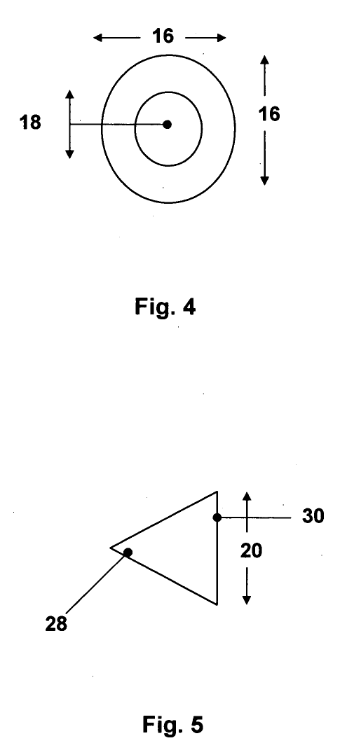

The aperture 10 located at the connecting end 8 is preferably configured such that one or more of the engaging elements 4 may pass and be pulled through the aperture 10 in a first direction, but not in a second (opposite) direction. More particularly, and referring to FIGS. 1, 4 and 5, starting with the first engaging element 4 located at the first end 6 of the teeth separator, the interconnected string of engaging elements 4 may be inserted into the aperture 10 and pulled therethrough. In certain preferred embodiments of the present invention, the apex portion 28 of the plurality of engaging elements 4 are inserted into and through the aperture 10 of the connecting end 8 to form a loop. As described below, the teeth separator 2 is preferably comprised of an elastomeric material, such that the engaging elements 4 and aperture 10 of the teeth separator 2 does exhibit some level of flexibility. Accordingly, even if the sides 30 (FIG. 5) of the substantially triangular or conically-shaped engaging elements 4 are larger than the diameter. 18 (FIG. 4) of aperture 10 at the connecting end 8, the preferably flexible nature of the engaging elements 4 and aperture 10 will allow the engaging elements 4 to bend, and the aperture 10 to be stretched, such that the engaging elements 4 may be pulled through the aperture 10 in a first direction to form a closed loop.

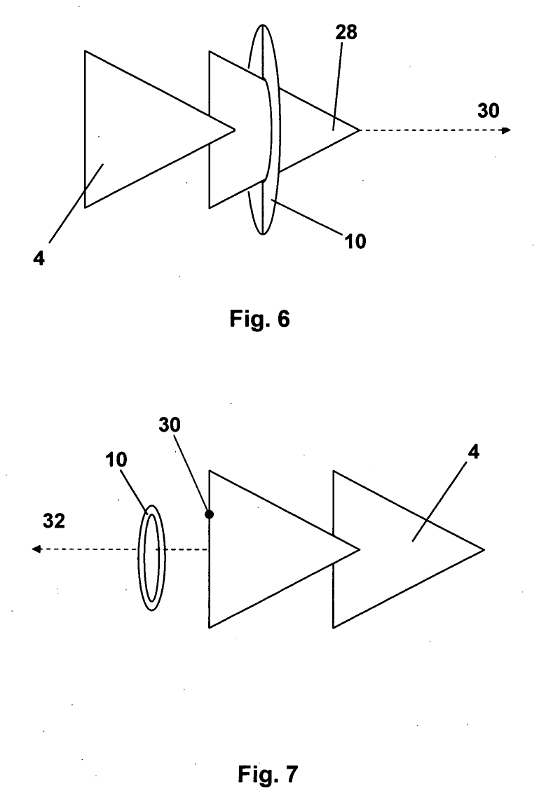

Referring to FIGS. 6 and 7, after the desired number of engaging elements 4 have been pulled through the aperture 10 in a first direction 30 (FIG. 6), the engaging elements 4 may not be pulled back through the aperture 10 in a second opposite direction 32 (FIG. 7). The engaging elements 4 may not be pulled back through the aperture 10 in a second opposite direction 32 because the region of the engaging elements 4, which exhibits the greatest dimension, is preferably configured to be larger than the diameter 18 of the connecting end 8. In addition, the orientation of the engaging elements 4 further prevents the engaging elements 4 from being pulled back through the aperture 10 in a second opposite direction 32. More specifically, while the apex 28 of each engaging element 4 is inserted into and pulled through the aperture 10 in a first direction 30 to form a loop (FIG. 6), if the same engaging elements 4 were pulled back through the aperture 10 in a second (opposite) direction 32, the side 30 of the engaging element 4 (or the region thereof which exhibits the greatest dimension) would lead (instead of the apex 28 leading (or the region of the engaging element 4 which exhibits the smallest dimension leading) as when it is initially pulled through in the first-direction 30). More specifically, for example, because the side 30 of the engaging element 4 shown in FIG. 7 would lead (i.e., be required to break through the aperture 10), instead of the apex 28, there is more resistance to such movement (and the aperture 10 will be less able to stretch to accommodate the engaging element 4), which prevents the engaging elements 4 from passing back through the aperture 10 in the opposite direction 32.

The invention provides that when it is said that the engaging elements 4 may pass through the aperture 10 in a first direction, but not in a second opposite direction, those of ordinary skill in the art will appreciate that such explanation means that the engaging elements 4 may be pulled through the aperture 10 in a first direction 30 (with the apex 28 thereof leading) with significantly less resistance, relative to an attempt to pull the same engaging elements 4 back through the aperture 10 in a second (opposite) direction 32. In other words, the invention provides that the engaging elements 4 may not easily be pulled back through the aperture 10 in a second (opposite) direction 32 without undue force or contortion of the engaging elements 4.

The teeth separators 2 described herein are, preferably, made of an elastomeric material, which allows the engaging elements 4 and aperture 10 to be somewhat flexible. Non-limiting examples of such elastomeric materials include silicone, latex rubber, polyurethanes, combinations thereof, or other suitable elastomers and/or polymers. For example, silastic silicone rubber may be used to manufacture the teeth separators 2 described herein, such as by molding a volume of silastic silicone rubber into the desired configuration. Non-limiting examples of suitable molding techniques include compression molding, injection molding, and transfer molding. Such molding techniques are similar to each other, insofar as each molding technique creates the rubber part (teeth separator 2) in a mold by applying pressure and heat thereto, which serves to shape and vulcanize the part. These methods vary in the mold loading method used, time and temperature of the molding cycle, and other details that may be relevant to a particular manufacturer. This notwithstanding, the invention provides that the teeth separators 2 described herein may be manufactured using any of the foregoing methods—or similar manufacturing techniques.

Still further, the invention provides that in certain embodiments the entire teeth separator 2 is made of one or more types of elastomeric materials, whereas in other embodiments only a portion thereof is made of an elastomeric material. For example, the invention encompasses teeth separators 2 made of a variety of materials, such as teeth separators 2 having engaging elements 4 made of an elastomeric material, with other parts made of another type of material.

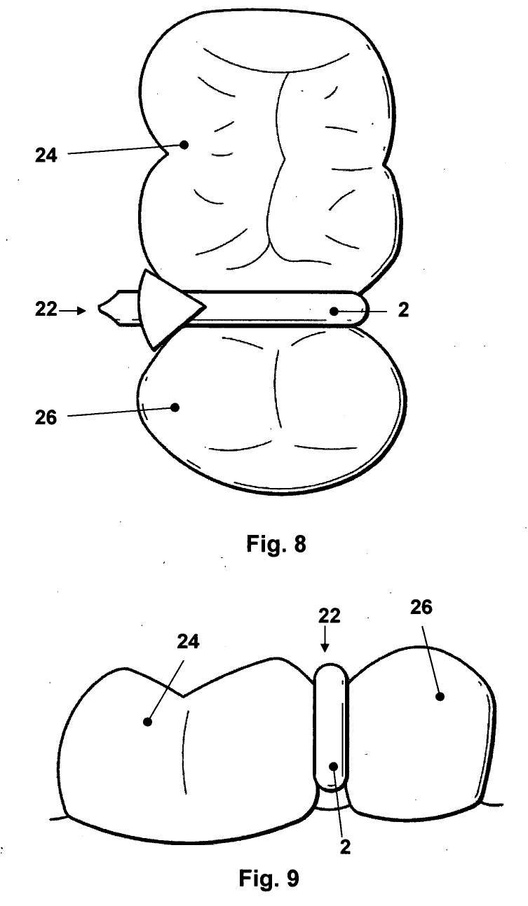

According to additional embodiments of the present invention, methods for separating teeth are provided. The methods generally comprise inserting a teeth separator 2 described herein between two teeth that are to be separated. More particularly, referring to FIGS. 8 and 9, the methods comprise looping the teeth separator 2 around the point of contact 22 and positioning the separator 2 between the two teeth 24,26 that are to be separated. As described herein, the preferred teeth separator used in such methods will be the teeth separators 2 described herein, which comprise a plurality of interconnected engaging elements 4, and a connecting end 8 which includes an aperture 10 through which one or more of the engaging elements 4 may pass in a first direction but not in a second (opposite) direction. Thus, looping the teeth separator 2 around the point of contact 22 between the two teeth 24,26 is achieved by pulling a first end 6 of the teeth separator 2 through the aperture 10 of the connecting end 8 in the first direction (as described above, e.g., with the apex 28 of the engaging elements 4 leading) until a loop of the desired dimension is achieved.

As shown in FIG. 1 for illustration purposes, the teeth separator 2 shown therein consists of 25 interconnected engaging elements 4. The first end 6 thereof, and the desired number of engaging elements 4, may be pulled through the aperture 10 to a distance (i.e., the desired number of engaging elements 4 may be pulled through the aperture 10) to achieve a loop of the desired dimensions, which will influence the overall size of the teeth separator 2 and the amount of separation force exerted upon the neighboring teeth 24,26 after it is installed in a patient's mouth. The methods of the present invention further comprise cutting and removing the excess portion of the teeth separator 2 which has passed through the aperture 10 in the first direction, as such excess portion of the teeth separator 2 is no longer needed after installation (and would otherwise protrude into and create discomfort within a patient's mouth). By using a teeth separator 2 described herein, which is initially used and installed having a total length 14 that is longer than needed post-installation, excess material is provided for an orthodontic practitioner to grip and maneuver, which facilitates installation.

The teeth separators 2 may be installed for a period of time that is sufficient to impart the desired space between two neighboring teeth 24,26. On average, the teeth separators may be installed in a patient's mouth for approximately 3-7 days. Following this period of time, the teeth separators 2 may be easily removed using a conventional hand instrument, such as a scaler or orthodontic plier.

An orthodontic practitioner may need to separate two neighboring teeth 24,26 for any of a variety of reasons. For example, two neighboring teeth may need to be separated to create room for a metal ring (known as a “band”) to be placed around a tooth. Once the band is installed, any of various attachments may be welded thereto, such as brackets, lugs, buttons, or others. This allows for mechanotherapy. Another purpose for separating two teeth is to move a tooth slightly in a particular direction, to treat or alleviate dental eruption (e.g., when a molar is impacted under a tooth in front of it).

There any many significant benefits provided by the teeth separators described herein (and methods of use thereof). For example, the separators are easily placed into position, and are simply looped around the contact point between two teeth and cut to the desirable length—much like a conventional brass wire. In addition, the teeth separators are more effective and flexible, insofar as an orthodontic practitioner can modulate the separating force exerted by the separators by varying the amount of activation thereof. In addition, the teeth separators described herein can be used with any patient, no matter his/her age, due to the adjustable nature of the teeth separators. In other words, because the teeth separators may be adjusted to exhibit any desired size, the teeth separators exhibit a “one size fits all” quality, unlike certain prior art elastomeric “O” rings and metal separators (which are offered in different sizes for different teeth and tightness of contacts).

Still further, the teeth separators may be constructed of any suitable elastomeric material, such as latex, silicone and a variety of elastomeric materials. This makes the separators safer for a patient, insofar as the risk and concerns regarding a patient swallowing a metal component are alleviated. Moreover, the teeth separators described herein are easy to install and, unlike certain prior art separators, they do not require the use of special instruments. Rather, any readily-available orthodontic instrument may be used to properly position the teeth separators of the present invention between two teeth, such as a Matheau ligating plier, cutters, etc. This user-friendly quality of the teeth separators is particularly advantageous with patients having tight tooth contacts.

Furthermore, the teeth separators of the present invention offer an improved level of comfort, relative to most prior art separators. This improved level of comfort may be attributed to several features of the separators. For example, the compact design of the separators prevents unwanted impingement on gingival. In addition, the separators do not include, for example, a protruding 360-degree loop of metal (which spring separators exhibit) or the cut twisted end of conventional brass wire separators. The teeth separators also provide an improved level of safety, insofar as the elastomeric material thereof is soft and poses no danger in fracturing opposing teeth (which can occur with metal or brass wire separators).

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A device for separating teeth, which comprises:
(a) a plurality of interconnected engaging elements; and
(b) a connecting end which comprises an aperture through which one or more of the engaging elements may pass in a first direction but not in a second opposite direction.

2. The device of claim 1, wherein each of the engaging elements exhibits at least two regions, wherein a first region exhibits a greater dimension than a second region.

3. The device of claim 2, wherein the engaging elements within a single device are (a) substantially the same size and (b) exhibit a substantially triangular or conical shape.

4. The device of claim 3, wherein each of the engaging elements, or a cross-section thereof, comprises three sides, wherein each side is about 1.25 mm in length.

5. The device of claim 1, wherein the aperture exhibits a substantially circular shape.

6. The device of claim 5, wherein the aperture is about 0.75 mm in diameter.

7. The device of claim 1, wherein the device is about 40 mm in length.

8. The device of claim 1, wherein the device is comprised of an elastomeric material.

9. The device of claim 8, wherein the elastomeric material is silicone, latex, or a combination thereof.

10. A method for separating teeth, which comprises inserting a teeth separator, and looping the teeth separator around a point of contact, between two teeth that are to be separated, wherein the teeth separator comprises:
(a) a plurality of interconnected engaging elements; and
(b) a connecting end which comprises an aperture through which one or more of the engaging elements may pass in a first direction but not in a second opposite direction.

11. The method of claim 10, wherein looping the teeth separator around the point of contact is achieved by pulling a first end of the teeth separator through the aperture in the first direction until a loop of the desired dimension is achieved.

12. The method of claim 11, which further comprises cutting and removing an excess portion of the teeth separator which has passed through the aperture in the first direction.

13. The method of claim 12, wherein each of the engaging elements exhibits at least two regions, wherein a first region exhibits a greater dimension than a second region.

14. The method of claim 13, wherein each of the engaging elements exhibits a substantially triangular or conical shape.

15. The method of claim 10, wherein the aperture exhibits a substantially circular shape.

16. The method of claim 10, wherein the device is comprised of an elastomeric material.

17. The method of claim 16, wherein the elastomeric material is silicone, latex, or a combination thereof.

18. The method of claim 10, wherein each of the engaging elements, or a cross-section thereof, comprises three sides, each of which is about 1.25 mm in length; the aperture is about 0.75 mm in diameter; and the device is about 40 mm in length.

19. The method of claim 10, which further comprises removing the teeth separator in approximately 3-7 days post-installation.

20. A method for separating teeth, which comprises:
(a) obtaining a teeth separator made of an elastomeric material that comprises:
(i) a plurality of interconnected engaging elements, each of which is approximately the same size and consists of three sides of about 1.25 mm in length; and
(ii) a connecting end which comprises a substantially circular aperture of about 0.75 mm in diameter through which one or more of the engaging elements may pass in a first direction but not in a second opposite direction;
(b) inserting the teeth separator between two teeth that are to be separated and looping the teeth separator around a point of contact by pulling a first end of the teeth separator through the aperture in the first direction until a loop of the desired dimension is achieved; and
(c) removing the teeth separator in approximately 3-7 days post-installation.
